(19) United States
(12) Patent Application Publication
(10) Pub. No.: US 2020/0279575 A1
(43) Pub. Date: Sep. 3, 2020

(54) AUTOMATIC GAIN CONTROL FOR SPEECH RECOGNITION ENGINE IN FAR FIELD VOICE USER INTERFACE

(71) Applicant: DSP Concepts, Inc., Santa Clara, CA (US)

(72) Inventor: Takahiro Unno, Santa Clara, CA (US)

(21) Appl. No.: 16/290,721

(22) Filed: Mar. 1, 2019

(51) Int. Cl. G10L 21/034; G10L 21/0208; G10L 15/22

(52) U.S. Cl. CPC G10L 21/034; G10L 2021/02082; G10L 15/22; G10L 21/0208

(57) ABSTRACT

An system and method for instantaneously adjusting input speech level of back-end ASR to the target level. The technology as disclosed and claimed herein is an AGC that can more rapidly adjust to the input speech level loudness to improve the performance of the back-end ASR engine without causing modulation or other artifacts in the speech signal.

### BACKGROUND

### Field

This technology as disclosed herein relates generally to hands free voice user interface system and, more particularly, to automatic gain control for speech recognition.

### Background

The dynamic range of speech level at microphone is very wide in a far-field voice user interface (UI) application. Also, a back-end automatic speech recognition (ASR) engine is generally sensitive to input speech level, and it requires consistent input speech level, for optimal performance. Many far-field voice UI systems are triggered by a wake word initially (e.g. “Alexa”®, “Hey Siri”® or “OK Google”®), and then connect to back-end cloud ASR. The duration of speech phrase for back-end ASR can typically be about approximately 3˜5 sec. Therefore, it is desirable that speech level adjustment for back-end ASR be made as close to instantaneously as possible or typically within the first about approximately 200˜300 ms of speech to provide optimal speech level to ASR engine. If constant gain is used instead of automatic gain control, back-end ASR performance is not optimal for wide range of speech level in far-field. Automatic gain control (AGC) has been widely deployed in mid-field and far-field voice communication and voice recording applications. A typical AGC adjusts speech level to the target level within typically 3˜5 seconds. Typical AGCs have been implemented in analog circuits, digital circuits or in the software of the DSP or general purpose processor. This technology has utility for speakerphones, conference call systems, voice dictation devices and for hands free voice user interface systems.

Many commercially available Voice User Interface (VUI) products have two stages of processing. In the first stage, a wake word detector running on the local device waits for a user to utter a wake word. Typical examples are “Alexa” ®, “Hey Siri”®, and “OK Google”®. In the second stage, the speech after the wake word is sent to a back-end automatic speech recognition (ASR) engine which can typically run on a cloud server. For example, a typical query might be “Hey Alexa, (short pause) what's the weather in San Francisco?”. The Hey Alexa trigger is detected by the local wake word engine and the phrase “what's the weather in San Francisco” is sent to the ASR. Typically queries are on the order of about approximately 3 to 10 seconds.

In far-field VUI systems the microphone(s) are typically remote from the user (about approximately 3 to 10 feet is typical). As such, the dynamic range of the voice loudness at the microphone is very wide. The level might vary between about approximately 45 dBSPL(A) and about approximately 80 dBSPL(a) in a typical household environment. Many commercial wake word detectors are designed to be insensitive to the input speech loudness level. However, most of the back-end ASR engines are sensitive to the input speech level loudness level. In turn, this means that performance in far-field VUI applications for the ASR engines tend to perform poorly.

Automatic Gain Control (AGC) has been widely used in commercial products to automatically adjust the speech level to a target level. Typical products that use AGC include speaker phones, conference call systems, and voice dictation services. AGCs are implemented in either analog circuits or on digital systems using software algorithms. AGCs normally operate by slowly and smoothly adapting to the input speech level over a “long” period of time. Typical adaptation times are on the order of about approximately 3 to 5 seconds. Unfortunately, for voice user interface products the duration of the query is fairly short (3 to 10 seconds as noted above) and conventional AGCs adjust too slowly.

The typical adaptation speed of AGC is typically too slow for back-end ASR engines in far-field voice UI system and improvement in this art area is needed. A better system and/or method is needed for improving AGC for back-end ASR engines.

### SUMMARY

The technology as disclosed herein includes a method and apparatus for instantaneously adjusting input speech level of back-end ASR to the target level. The technology as disclosed and claimed herein is an AGC that can more rapidly adjust to the input speech level loudness to improve the performance of the back-end ASR engine without causing modulation or other artifacts in the speech signal.

One implementation of the fast-adjusting AGC operation is illustrated by the following steps:

1. A target speech level for the ASR engine is specified. This level may be specified one time for the life of the product or slowly adapt (over hours or days) as the ASR system changes/learns using a learning algorithm. The target level can be either peak or RMS level.

2. The original voice signal is processed using a fast-attack/slow-release function. For one implementation of the technology this signal is the same signal that is being sent to the wake word engine. Note that for one implementation noise and echo cancellers are used to eliminate unwanted acoustic signals so that the voice signal is typically about approximately 10 to 20 dB louder than any background noise.

3. When the wake word is detected, the system latches the peak value of the voice signal as output from the fast-attack/slow-release. This level corresponds to the approximate loudness of the wake word.

4. The gap between the target level (Step 1) and the peak level of the speech (Step 3) is determined and a gain is applied such that the output of speech is made about approximately equal to the target.

5. In some cases, additional gain is applied to the speech level in Step 4. For example, most users might speak such that the wake word utterance might be slightly louder than the follow-on query. In this case, additional gain might be required for the input to the ASR. By way of illustration this might require additional 5 dB to adjust ASR speech level to the target level more accurately. If a target level is specified in RMS, it will require additional gain of about approximately 10 dB to compensate a difference of speech peak and RMS level.

6. In some cases the system applies the level of re-adjusted gap in (5) immediately after a wake word is detected. That will instantaneously adjust input speech level of back-end ASR engine.

The features, functions, and advantages that have been discussed can be achieved independently in various implementations or may be combined in yet other implementations further details of which can be seen with reference to the following description and drawings.

These and other advantageous features of the present technology as disclosed will be in part apparent and in part pointed out herein below.

### BRIEF DESCRIPTION OF THE DRAWINGS

For a better understanding of the present technology as disclosed, reference may be made to the accompanying drawings in which:

FIGS. 1A and 1B are illustrations of the instantaneous AGC behavior;

FIG. 2 is an illustration of the Instantaneous AGC implementation;

While the technology as disclosed is susceptible to various modifications and alternative forms, specific implementations thereof are shown by way of example in the drawings and will herein be described in detail. It should be understood, however, that the drawings and detailed description presented herein are not intended to limit the disclosure to the particular implementations as disclosed, but on the contrary, the intention is to cover all modifications, equivalents, and alternatives falling within the scope of the present technology as disclosed and as defined by the appended claims.

### DESCRIPTION

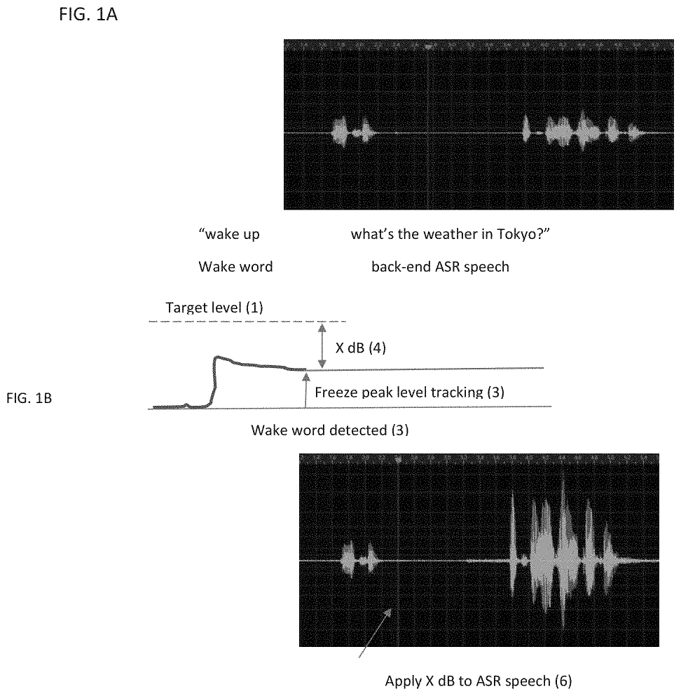

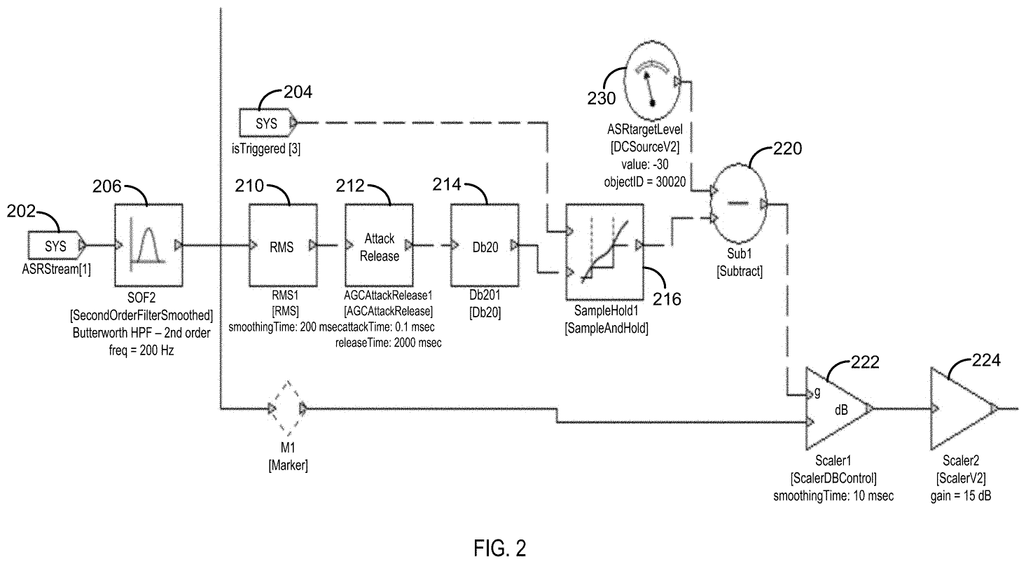

According to the implementation(s) of the present technology as disclosed, various views are illustrated in FIGS. 1A-1B and 2 and like reference numerals are being used consistently throughout to refer to like and corresponding parts of the technology for all of the various views and figures of the drawing. Also, please note that the first digit(s) of the reference number for a given item or part of the technology should correspond to the FIG. number in which the item or part is first identified. Reference in the specification to “one embodiment” or “an embodiment”; “one implementation” or “an implementation” means that a particular feature, structure, or characteristic described in connection with the embodiment or implementation is included in at least one embodiment or implementation of the invention. The appearances of the phrase “in one embodiment” or “in one implementation” in various places in the specification are not necessarily all referring to the same embodiment or the same implementation, nor are separate or alternative embodiments or implementations mutually exclusive of other embodiments or implementations.

One implementation of the present technology as disclosed comprising instantaneous AGC teaches a novel system and method for instantaneously adjusting input speech level of back-end ASR to the target level.

The details of the technology as disclosed and various implementations can be better understood by referring to the figures of the drawing. Referring to FIGS. 1A and 1B, a behavior of the instantaneous AGC operation is illustrated by the following steps:

1. A target speech level for the ASR engine is specified. For one implementation, this level is specified one time for the life of the product or is slowly adapt (over hours or days) as the ASR system changes/learns using a machine learning algorithm. For one implementation, the target level is either peak or RMS level.

2. The original voice signal is processed using a fast-attack/slow-release function. This signal can be the same signal that is being sent to the wake word engine. Note that for one implementation noise and echo cancellers are used to eliminate unwanted acoustic signals so that the voice signal is typically about approximately 10 to 20 dB louder than any background noise.

3. When the wake word is detected, the system latches the peak value of the voice signal as output from the fast-attack/slow-release. This level corresponds to the approximate loudness of the wake word.

4. The gap between the target level (Step 1) and the peak level of the speech (Step 3) is determined and again is applied such that the output of speech is made about approximately to equal the target.

5. In some cases, additional gain may be applied to the speech level in Step 4. For example, most users might speak such that the wake word utterance might be slightly louder than the follow-on query. In this case, additional gain might be required for the input to the ASR. By way of illustration this might require additional 5 dB to adjust ASR speech level to the target level more accurately. If target level is specified in RMS, it will require additional gain of about 10 dB to compensate a difference of speech peak and RMS level.

6. In some cases the system applies the level of re-adjusted gap in (5) immediately after a wake word is detected. That will instantaneously adjust input speech level of back-end ASR engine.

Referring to FIG. 2, an Instantaneous AGC Block Diagram is illustrated. FIG. 2 shows a block diagram of one implementation of the Instantaneous AGC. The inputs to the block diagram are:
1. ASRStream 202: This is the microphone signal that is sent to the wake word detector as well as the ASR. The goal of the block diagram is to process the ASRStream signal 202 to achieve the desired level.
2. isTriggered 204: This is a Boolean input corresponding to the wake word engine acknowledging that it has been triggered.
   The ASRStream signal is first processed by a 200 Hz high pass Second Order Filter (SOF2) 206. For one implementation as shown a Butterworth High Pass Second Order Filter is us with a frequency of 200 Hz. The band pass filter is utilized to pass frequencies in the typical voice range and attenuate other frequencies. This is useful in voice applications since human voice has very little content below 200 Hz. The type of band pass filter may vary depending on the type of audio being operated on. The RMS value of the signal is then computed using a 200 mSec window RMS function (RMS1) 210. This short duration means that the output of the RMS block increases and decreases quickly in response to the microphone signal. Next, the ASRStream signal is next sent to the fast-attack/slow-release block (AGCAttackRelease1) 212. By way of illustration, the attack time is set to be very small (about approximately 0.1 msec in the implementation as illustrated) and the release time is much slower (about approximately 2 seconds in this example). The output is then converted to dB (Db201) logarithmic gain 214. These variables can change depending on the application.

Dynamic range compression (DRC) or simply compression is an audio signal processing operation that reduces the volume of loud sounds or amplifies quiet sounds thus reducing or compressing an audio signal's dynamic range. Compression is commonly used in sound recording and reproduction, broadcasting, live sound reinforcement and in some instrument amplifiers. A compressor may provide a degree of control over how quickly it acts. The attack is the period when the compressor is decreasing gain in response to increased level at the input to reach the gain determined by the ratio. The release is the period when the compressor is increasing gain in response to reduced level at the input to reach the output gain determined by the ratio, or, to unity, once the input level has fallen below the threshold. Because the loudness pattern of the source material is modified by the time-varying operation of compressor, it may change the character of the signal in subtle to quite noticeable ways depending on the attack and release settings used. The length of each period is determined by the rate of change and the required change in gain. When the wake word engine detects a trigger, the Triggered input goes from 0 to 1 and a sample-and-hold (SampleHold1) 216 captures the dB level of the ASRStream. The gain difference between the target level (ASRtargetLevel) (about approximately −30 dB in this example) and the output of the sample-and-hold is then determined by a subtraction function 220. This gain is then applied to the ASRStream signal (Scaler1) 222. As noted in Step 5 above, additional gain may be applied (Scaler2) 224. Some voice user interface systems require a delay between the wake word and the start of the query. As such, a latch might be needed to hold the output of the wake word level so the sample and hold stays active for a long enough period of time. The target level for the ASR 230 might need to be adjusted as the ASR system learns and adapts rather than just being a static value.

The various implementations and examples shown above illustrate a method and system for Instantaneous AGC. A user of the present method and system may choose any of the above implementations, or an equivalent thereof, depending upon the desired application. In this regard, it is recognized that various forms of the subject Instantaneous AGC method and system could be utilized without departing from the scope of the present technology and various implementations as disclosed.

As is evident from the foregoing description, certain aspects of the present implementation are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from scope of the present implementation(s). Accordingly, the specification and drawings are to be regarded in an illustrative rather than a restrictive sense.

Certain systems, apparatus, applications or processes are described herein as including a number of modules. A module may be a unit of distinct functionality that may be presented in software, hardware, or combinations thereof. When the functionality of a module is performed in any part through software, the module includes a computer-readable medium. The modules may be regarded as being communicatively coupled. The inventive subject matter may be represented in a variety of different implementations of which there are many possible permutations.

The methods described herein do not have to be executed in the order described, or in any particular order. Moreover, various activities described with respect to the methods identified herein can be executed in serial or parallel fashion. In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

In an example implementation, the machine operates as a standalone device or may be connected (e.g., networked) to other machines. For example in this case the Instantaneous AGC system can be connected to an ASR system. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine or computing device. Further, while only a single machine is illustrated, the term “machine” shall also be taken to include any collection of machines that individually or jointly execute a set (or multiple sets) of instructions to perform any one or more of the methodologies discussed herein.

The computer system and client computers can include a processor (e.g., a central processing unit (CPU) a graphics processing unit (GPU) or both), a main memory and a static memory, which communicate with each other via a bus. The computer system may further include a video/graphical display unit (e.g., a liquid crystal display (LCD) or a cathode ray tube (CRT)). The computer system and client computing devices can also include an alphanumeric input device (e.g., a keyboard), a cursor control device (e.g., a mouse), a drive unit, a signal generation device (e.g., a speaker) and a network interface device.

The drive unit includes a computer-readable medium on which is stored one or more sets of instructions (e.g., software) embodying any one or more of the methodologies or systems described herein. The software may also reside, completely or at least partially, within the main memory and/or within the processor during execution thereof by the computer system, the main memory and the processor also constituting computer-readable media. The software may further be transmitted or received over a network via the network interface device.

The term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present implementation. The term “computer-readable medium” shall accordingly be taken to include, but not be limited to, solid-state memories, and optical media, and magnetic media.

The various instantaneous AGC examples shown above illustrate an improved ASR system. A user of the present technology as disclosed may choose any of the above AGC implementations, or an equivalent thereof, depending upon the desired application. In this regard, it is recognized that various forms of the subject instantaneous AGC system could be utilized without departing from the scope of the present invention.

As is evident from the foregoing description, certain aspects of the present technology as disclosed are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the scope of the present technology as disclosed and claimed.

Other aspects, objects and advantages of the present technology as disclosed can be obtained from a study of the drawings, the disclosure and the appended claims.

What is claimed is:

1. An automatic gain control system for an automatic speech recognition engine comprising:
a dynamic range compression module configured to perform an operation of attacking and releasing an audio signal for dynamic range compression and outputting an attack and release audio signal;
a sample and hold module communicably coupled to receive the attack and release audio signal from the dynamic range compression module and said sample and hold module configured to perform an operation of receiving, holding and sampling the attack and release signal responsive to an wake-word trigger signal and latching a peak level of the attack and release signal; and
a subtraction module that is configured to perform the operation of determining the difference between a target gain level and the latched peak level and applying a gain to the audio signal to adjust for the difference.

2. The automatic gain control system as recited in claim 1, comprising:
a band pass filter configured to perform an operation of band pass filtering an original signal thereby producing a band pass filtered signal; and
an RMS module communicably coupled to receive the band pass filtered signal and said RMS module configured to perform a route mean square function on the band pass filtered signal to thereby produce the audio signal for transmission to the dynamic range compression module.

3. The automatic gain control system as recited in claim 2, comprising:
a noise and echo cancellation module configured to perform the function of preprocessing the original signal to attenuate audio noise and audio echoes.

4. The automatic gain control system as recited in claim 2, where the band pass filter is a 200 Hz second order high pass band pass filter.

5. The automatic gain control system as recited in claim 2, where the RMS module operates using a 200 mSec window.

6. The automatic gain control system as recited in claim 2, where the dynamic range compression module has an attack time set to about approximately 0.1 milliseconds and a release time set to about approximately 2 seconds.

7. A method for automatic gain control for an automatic speech recognition engine comprising:
attacking and releasing an audio signal with a dynamic range compression module configured to perform an operation of for dynamic range compression and outputting an attack and release audio signal;
receiving the attack and release audio signal at a sample and hold module from the dynamic range compression module and said sample and hold module configured to perform an operation of receiving, holding and sampling the attack and release signal responsive to an wake-word trigger signal and latching a peak level of the attack and release signal; and
determining the difference between a target gain level and the latched peak level and applying a gain to the audio signal to adjust for the difference.

8. The method for automatic gain control system as recited in claim 7, comprising:
filtering an original signal with a band pass filter configured to perform an operation of band pass filtering thereby producing a band pass filtered signal; and
performing a route mean square function on the band pass filtered signal with an RMS module communicably coupled to receive the band pass filtered signal to thereby produce the audio signal for transmission to the dynamic range compression module.

9. The method for automatic gain control as recited in claim 8, comprising:
preprocessing the original signal thereby attenuating audio noise and audio echoes with a noise and echo cancellation module.

10. The method for automatic gain control as recited in claim 8, where the band pass filter is a 200 Hz second order high pass band pass filter.

11. The method for automatic gain control as recited in claim 8, where the RMS module operates using a 200 mSec window.

12. The method for automatic gain control as recited in claim 8, where the dynamic range compression module has an attack time set to about approximately 0.1 milliseconds and a release time set to about approximately 2 seconds.
